(19) United States
(12) Patent Application Publication
(10) Pub. No.: US 2023/0232800 A1
(43) Pub. Date: Jul. 27, 2023

(54) FISHING LURE TROLLING TRACKER CHAIN

(71) Applicant: Sterling Tackle, LLC, South Marmora, NJ (US)

(72) Inventors: Steven Edward Breunig, Marmora, NJ (US); Elliot Breunig, Marmora, NJ (US)

(21) Appl. No.: 17/648,605

(22) Filed: Jan. 21, 2022

(51) Int. Cl. A01K 85/12

(52) U.S. Cl. CPC A01K 85/12

(57) ABSTRACT

Embodiments relate to a single line of a plurality of interconnected bait lures. At least one bait lure can have an elongated body, an angled keel, and a lateral wing. These elements work together to ensure that the single line of a plurality of interconnected bait lures run wide from behind a fishing vessel to expose the lures to favorable water conditions and thereby eliminating the need for expensive outrigger devices.

### FIELD OF THE INVENTION

Embodiments relate to fishing lures, particularly to a single line of a plurality of interconnected bait lures that are used while trolling.

### BACKGROUND OF THE INVENTION

Fishing lures being trolled behind a fishing vessel track an essentially straight path behind the point from which they are pulled (e.g., a rod tip or outrigger release). However, lures that run wide from behind the fishing vessel run in so-called “clean water,” which is water that is essentially undisturbed by the vessel's engine turbulence/bubble trail and wake. Clean water provides better visibility of the lures as well as a more natural setting to the predator fish who do most of their feeding in natural clean water. Further, lures that run wide eliminate the need for expensive outriggers attached to each side of the fishing vessel. Accordingly, there is a need for improved systems and methods for trolling that allows for lures to run wide from behind the vessel to expose the lures to a greater number of fish and therefore more opportunities for fish to see and strike the lures.

The inventive tracker chain is deemed to be “legal” in many tournaments where “tracker bar” type lure assemblies are “illegal,” giving the fisherman a distinct ability to catch more fish and increase the chances to win prize money.

### SUMMARY OF THE INVENTION

Embodiments relate to a single line of a plurality of interconnected bait lures. A bait lure comprises a body having an angled keel, which helps guide the body laterally outwardly from its direction of travel when trolling. The body also has at least one lateral wing. These elements work together to ensure that the single line of a plurality of bait lures run wide form behind a fishing vessel to expose the lures to favorable water conditions.

In an exemplary embodiment, a trolling device comprises a plurality of interconnected bait lures. Each bait lure has a body having a keel, wherein the keel extends from a ventral surface of the body at an angle relative to a longitudinal axis of the body, such that, when trolling in a body of water at or near a surface of the body of water, the body is guided laterally outwardly from a direction of travel. The body also has a lateral wing extending outwardly from the body. Each bait lure also has a head end and a tail end.

In some embodiments, the plurality of interconnected bait lures are interconnected by a line extending between the tail end of a preceding bait lure and the head end of a succeeding bait lure.

In some embodiments, the plurality of interconnected bait lures create a lateral separation when trolling, wherein the lateral separation increases as the number of interconnected bait lures increases.

In some embodiments, at least one of the bait lures has at least one hook secured thereto.

In some embodiments, the keel is configured to facilitate adjustment of the angle at which the keel makes relative to the longitudinal axis of the body.

In some embodiments, at least one of the bait lures has a rotatable base plate comprising at least two sliding grooves for receiving screws to secure the rotatable base plate to the body, wherein the keel is affixed to the rotatable base plate.

In some embodiments, at least one of the bait lures has a rotatable base plate comprising at least two sliding grooves and at least two notches for receiving screws to secure the rotatable base plate to the body, wherein the notches are provided within the at least two sliding grooves, and the keel is affixed to the rotatable base plate.

In some embodiments, at least one of the d bait lures has a rotatable base plate comprising the keel secured thereto, and the body has at least a pair of threaded holes for receiving screws for securement of the rotatable base plate to the body.

In some embodiments, the keel and the rotatable base plate are a single molded or machine piece.

In some embodiments, the rotatable base plate and the elongated body are configured such that the rotatable base plate is rotatable about a central axis while remaining on the body.

In some embodiments, the rotatable base plate has at least one sliding groove through which screws are inserted to secure the rotatable base plate to the body via the threaded holes of the body.

In some embodiments, the trolling device further comprises at least one pair of notches in the at least one sliding groove, wherein the at least one pair of notches is configured to accept the screws and permit said screws to be tightened into the threaded holes of the body.

In some embodiments, the pitch of the wing is adjustable.

In some embodiments, the body is an elongated body and configured to assist with planing lift.

In an exemplary embodiment, a trolling device comprises a bait lure. The bait lure has a body having a keel, wherein the keel extends from a ventral surface of the body at an angle relative to a longitudinal axis of the body, such that, when trolling in a body of water at or near a surface of the body of water, the body is guided laterally outwardly from a direction of travel. The body also has a lateral wing extending outwardly from the body. The bait lure also has a head end and a tail end, and a line extending from the head end. The keel and the lateral wing work in conjunction to provide stability and planing lift for the bait lure when the bait lure is caused to troll in a body of water such that the bait lure maintains a position on or below a surface of the water in a stabile manner.

In some embodiments, the trolling device also comprises a plurality of lateral wings.

In some embodiments, the trolling device also comprises a plurality of keels.

In an exemplary embodiment, a trolling device comprises a plurality of bait lures. Each bait lure has a body having a keel, wherein the keel extends from a ventral surface of the body at an angle relative to a longitudinal axis of the body, such that, when trolling in a body of water at or near a surface of the body of water, the body is guided laterally outwardly from a direction of travel. The body also has a lateral wing extending outwardly from the body. Each bait lure also has a head end and a tail end, wherein each preceding-succeeding bait lure pair of the plurality of bait lures includes a line extending between the tail end of the preceding bait lure and the head end of the succeeding bait lure. The keel and the lateral wing of each bait lure work in conjunction to provide stability and planing lift for the trolling device when the trolling device is caused to troll in a body of water such that the trolling device maintains a position on or below a surface of the water in a stabile manner.

In some embodiments, the line for the trolling device consists of a single unitary line.

In some embodiments, the line for the trolling device comprises a plurality of line segments.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows a schematic view of the single line of a plurality of interconnected bait lures in use while trolling.

FIG. 2 shows a bottom view of two interconnected bait lures.

FIG. 3 shows an embodiment of a body.

FIG. 4 shows a bottom view of a rotatable base plate having at least two sliding grooves and notches.

FIG. 5 shows a bottom view of a rotatable base plate having at least two sliding grooves and notches, the rotatable base plate being provided on a body.

FIG. 6 shows a bottom view of a rotatable base plate having at least two sliding grooves and notches, the rotatable base plate being secured to the body wherein screws are inserted for securing said rotatable base plate to a body.

FIG. 7 shows a bottom view of a body having threaded holes.

FIG. 8 shows a front view of an embodiment of a body having two lateral wings and a fixed keel.

FIG. 9 shows a bottom view of an embodiment of a body having two lateral wings and a fixed keel.

FIG. 10 shows a schematic view of the increase in lateral separation as more bait lures are added.

FIG. 11 shows a schematic view of the single line of a plurality of interconnected bait lures in use with a detached hook bait.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

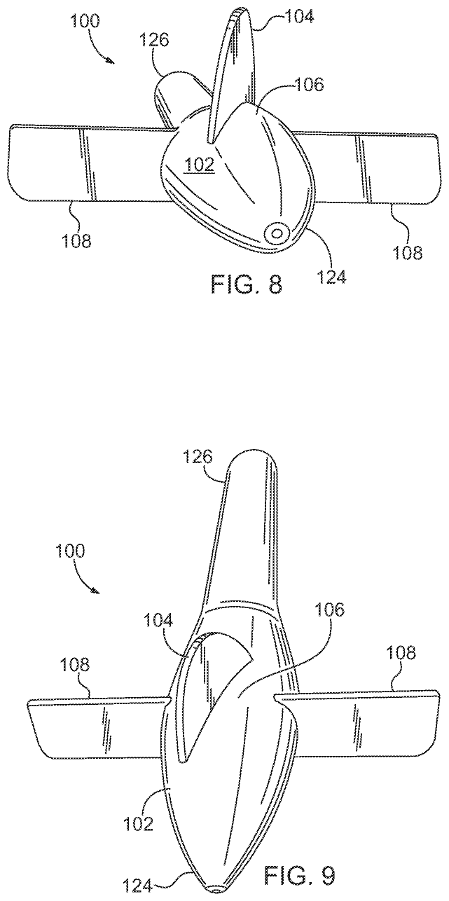

Embodiments relate to a single line of a plurality of interconnected bait lures that are used while trolling. A bait lure 100 is comprised of a body 102. The body 102 has a head end 124 and a tail end 126 with a longitudinal axis Lx (see FIG. 3) running from the head end 124 to the tail end 126. When moving through the water in a forward direction (e.g., when trolling), the head end 124 spearheads the movement through the water. The body 102 may be in the form of any shape, such as a sphere-like, cylinder-like, prism-like, or cone-like element, and it is contemplated that the body 102 is in the form of a fish or squid bait. The body 102 can also be elongated. It is further contemplated that the body 102 may be torpedo-shaped, wherein the body 102 is elongated and tapers in from the body's center towards the head end 124 and likewise tapers in from the body's center towards the tail end 126 (see FIGS. 8 and 9).

The body 102 has a keel 104 that extends from a ventral surface 106 of the body 102 at an angle relative to a longitudinal axis Lx of the body 102. The keel 104 can be a planar member having a head end surface (e.g. a surface facing the head end 124) and a tail end surface (e.g., a surface facing the tail end 126). The keel 104 can have a rectangular shape, square shape, triangular shape, trapezoidal shape, etc. Because the keel 104 can be arranged to be at an angle that is not normal to Lx, the head end surface defines an angled keel area. It is understood that the keel 104 can be arranged to be at an angle that is normal to Lx, but it is contemplated for it to be a non-normal angle. The angled keel area is defined by a surface area of the head end surface that abuts the water when the bait lure 100 is moved in a forward direction. Locating the keel 104 on the ventral surface 106 keeps at least a portion of the keel 104 (which can include the entire keel 104, a portion of the angled keel area, etc.) below the surface of the water during planing. Planing is a movement behavior in which the body 102 maintains a position on top of or approximately six to twelve inches below a surface of the water when moving forward.

Embodiments can allow for the body 102 to maintain a position below the surface of water, but it is contemplated that the body 102 maintains a position on top of the surface of water. The ventral surface 106 refers to the surface comprising the underside of the body 102 (e.g., if the lure 100 were placed on top of the water, the ventral surface 106 would be facing the water).

It is contemplated that at least one of the interconnected bait lures 100 has at least one hook 110 secured thereto, so as to catch a fish that may strike the lure 100. The at least one hook 110 may be affixed to any location on a bait lure 100. The lures 100 and/or the hooks 110 may also include a natural bait, such as a squid, crustacean, a baitfish, and the like.

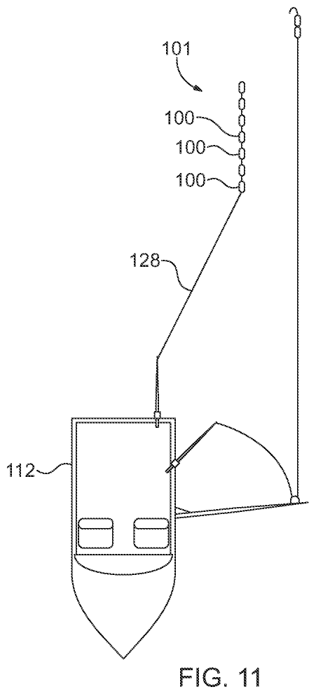

It is further contemplated that a detached hook bait may be used with at least one of the interconnected bait lures 100 (see FIG. 11). A detached hook bait is a nearby bait and/or hook mechanism that originates from a separate rod and is not part of the interconnected bait lures 100, wherein the interconnected bait lures 100 become a teaser bait. Use of a nearby detached hook bait obviates the use of a hook 110 on at least on the interconnected bait lures 100, but at least one of the interconnected bait lures 100 may nevertheless have at least one hook 110 secured thereto.

The body 102 can also have at least one lateral wing 108 extending outwardly from the body 102. For instance, the at least one lateral wing 108 can be attached to the body 102. The at least one lateral wing 108 can have a rectangular shape, square shape, triangular shape, trapezoidal shape, etc. It is contemplated for the at least one lateral wing 102 to extend from a side of the body 102 and extend laterally outward. This can include extending at any angle from the body 102 (e.g., the lateral wing 108 can extend straight out, be swept forward, swept backward, angled down (towards the ventral surface 106), angle upward (away from the ventral surface 106), etc.) There can be more than one lateral wing 108. It is contemplated for the body 102 to have two lateral wings 108. One lateral wing 108 can extend from one side of the body 102 with another lateral wing 108 extending from another side of the body 102. The first lateral wing 108 can subtend the second lateral wing 108 so as to extend from a same location on the longitudinal axis Lx as that of the first lateral wing 108. However, other arrangements and placement of lateral wings 108 can be used. Moreover, any one or combination of lateral wings 108 can be angled up, while the other is angled down, swept forward while the other is swept backward, etc.

The lateral wing 108 and/or the keel 104 provide or improve stability and/or improve or provide planing lift. Stability refers to the movement behavior of the body 102 when moving forward that involves the body 102 planing without: skipping on the water surface; moving about erratically (e.g., flopping, spinning, rotating, etc.); undulating, diving, banking, listing, etc. Stability also refers to the ability of the body 102 to self-right to its ordinary position (e.g., with head end 124 spearheading movement, keel 104 below the surface of the water, and ventral surface 106 facing the water). It is contemplated that stability may be achieved as the body 102 oscillates or rotates rapidly about its longitudinal axis Lx along a line 128. The oscillating or rotating movement is naturally created as the lure 100 is pulled through water. In an exemplary embodiment in which a body 102 has one fixed lateral wing 108 extending from one side of the body 102 and another fixed lateral wing 108 extending from the opposite side of the body 102, one fixed lateral wing 108 may contact the water surface, causing the wing 108 to quickly rise from the water surface and causing the body 102 to oscillate or rotate about its longitudinal axis Lx along a line 128 and compelling the other fixed lateral wing 108 to lower until contacting the water surface before quickly rising—this process is continuous and repetitive. This rapid oscillation or rotation contributes to stability as the lateral wings 108 work in tandem to put the body 102 in an equilibrium state while maintaining the original orientation and position of the body 102, even in the face of external forces (e.g., waves, currents, etc.).

Planing lift refers to providing enough lift to the body 102 to maintain planing—the body 102 maintains a position on top of or approximately six to twelve inches below a surface of the water when moving forward. As noted above, embodiments can allow for the body 102 to maintain a position below the surface of water, but it is contemplated that the body 102 maintains a position on top of the surface of water. Desired lift can be generated by the number, size, geometry, angle, shape of the lateral wing(s) 108 and/or keel(s) 104. For instance, the lateral wing 108 can have a curved top surface with a straight bottom surface so as to generate a fluid pressure differential when fluid (e.g., water) is being forced over it. In addition, the size, geometry, angle, shape of the body 102 can be factored in when devising the number, size, geometry, angle, shape of the lateral wing(s) 108 and/or keels (104) that will generate a desired planing lift and/or stability.

The body 102 itself may also provide or improve planing lift. For example, it is contemplated that the body 102 may be torpedo-shaped, wherein the body 102 is elongated and tapers in from the body's center towards the head end 124 and likewise tapers in from the body's center towards the tail end 126 (see FIGS. 8 and 9). The curved shape of the body 102 allows for water to flow over top of the body 102 faster than underneath the body 102, resulting in less air pressure on top of the body 102 and natural lift.

It is contemplated that the lateral wing 108 may be adjustable about a lateral axis Ly (see FIG. 3) of the body 102 to permit a user to set the angle of the lateral wing 108 to control the depth at which the lure assembly may travel when trolling. For instance, depending on considerations like water conditions and target species, a user may adjust the lateral wing 108 to ensure prevention of subsurface diving or to facilitate subsurface diving. Adjustment can be rotational adjustment about Ly (e.g. adjusting the pitch of the wing 108), and thus the angle of adjustment can be the angle at which the front-facing surface of the wing 108 faces the forward direction). Adjustment can be achieved via a spring-loaded rotational assembly, for example. For instance, the wing 108 can be in mechanical connection with a spring-loaded rotational assembly in which a user pulls the wing 108 out from the body 102 to disengage a pin or detent formed in a plate or collar within the body 102 to allow rotation of the wing about Ly to a desired position (e.g., adjust the wing 108 about the pitch axis of the bait lure 100). A user can then release the wing 108 allow it to advance back towards the body 102 and towards the plate or collar so that a pin-detent engagement occurs. Once the pin-detent engagement occurs, no further rotation of the wing 108 relative to the body 102 can occur. As another example, a ratchet lever mechanism can be used to facilitate adjustment of the wing's 108 forward, rearward, upward, or downward sweep.

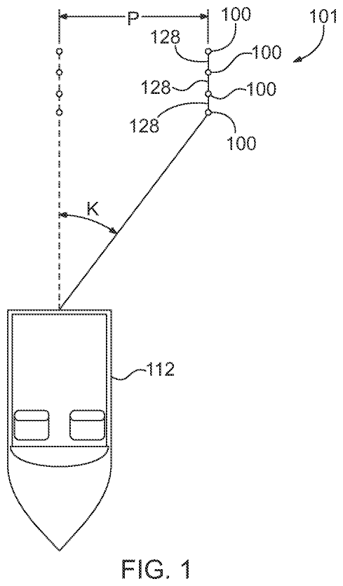

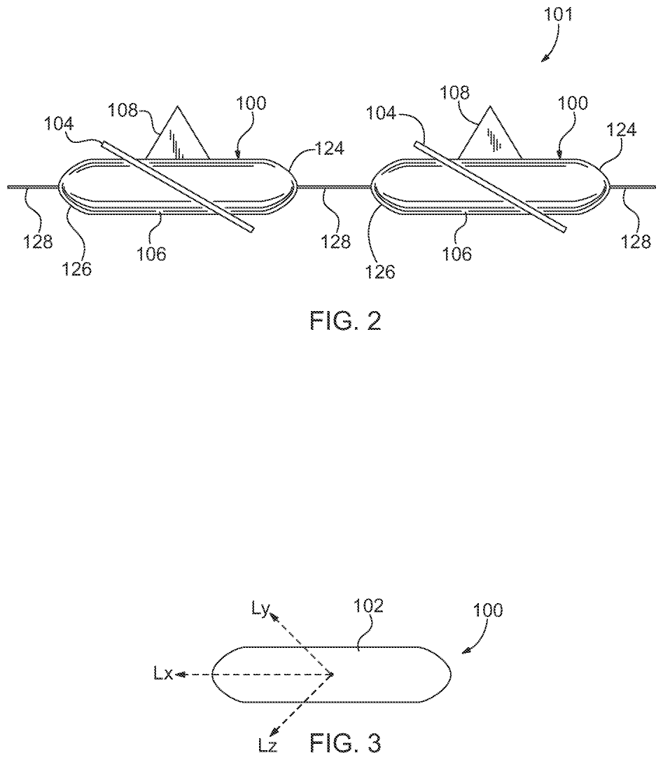

As noted above, the keel 104 can be angled such that the body 102 is guided outwardly from a direction of travel from a fishing vessel 112 while trolling in a body of water at or near a surface of the body of water. It is contemplated that the angle of the keel 104 relative to the longitudinal axis Lx of the body 102 may be adjustable to allow the bait lure 100 to be guided outwardly at different positions or angles. For example, a user may be able to easily set the single line of a plurality of interconnected bait lures behind the vessel 112 at varying angles K (see FIG. 1) and lateral separation P (see FIG. 1). It is contemplated that keels adjusted to positions of 30 to 35 degrees relative to the longitudinal axis Lx of the body 102 would result in optimum separation for a trolling spread. A person of ordinary skill in the art would understand and appreciate that a keel 104 adjusted to a position of 45 degrees relative to the longitudinal axis of the body 102 would result in the lure 100 to be pushed the furthest distance laterally outwardly from the fishing vessel 112.

It is contemplated that the keel 104 be in a fixed position on the body 102. It is further contemplated that the body 102 may also have a rotatable base plate 114 positioned on the ventral surface 106 of the body 102. The rotatable base plate 114 may be circular or essentially circular to permit rotation about a central axis Lz (see FIG. 3). The keel 104 may be securely affixed to the rotatable base plate 114. The rotatable base plate 114 allows the angle of the keel 104 to be adjusted to allow the bait lure 100 to be guided outwardly at different positions or angles. For instance, the adjustment of the keel 104 can be about the yaw axis of the bait lure 100 (e.g., axis Lz).

The rotatable base plate 114 may have at least two sliding grooves 116 through which screws 118 extend into the body 102 to secure the rotatable base plate 114 to the body 102. When the screws 118 are loosened, the rotatable base plate 114 may be freely rotated about a central axis Lz such that the screws 118 may be tightened for setting the keel 104 at a desired position or angle. When the screws 118 are loosened, the screws 118 may travel through the sliding grooves 116. Alternatively, the rotatable base plate 114 may have at least two sliding grooves 116 and at least two notches 120 through which screws 118 extend into the body 102 to secure the rotatable base plate 114 to the body 102. The notches 120 may be positioned within the at least two sliding grooves 116.

The sliding grooves 116 and/or the notches 120 may be threaded. The sliding grooves 116 and/or the notches 120 may be essentially the same size as the major diameter of the screws 118 inserted therein or of the shanks of the screws 118 inserted therein. The sliding grooves 116 and/or the notches 120 should accommodate the screws 118 such that, when the screws 118 are inserted into the sliding grooves 116 or notches 120, the screws 118 can be countersunk or essentially countersunk into the rotatable base plate 114 when tightened. The sliding grooves 116 and notches 120 may be located near or toward the outer edge or perimeter or circumference of the rotatable base plate 114.

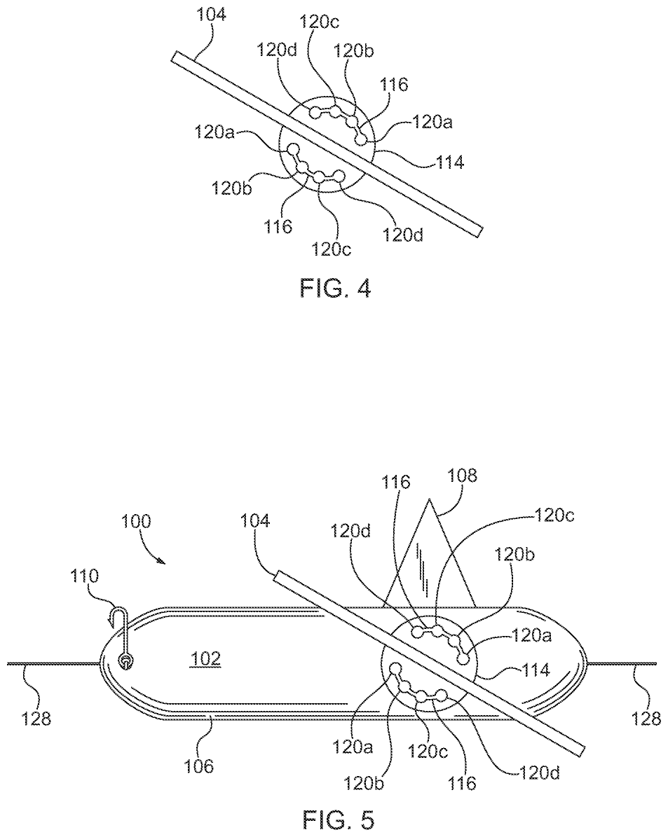

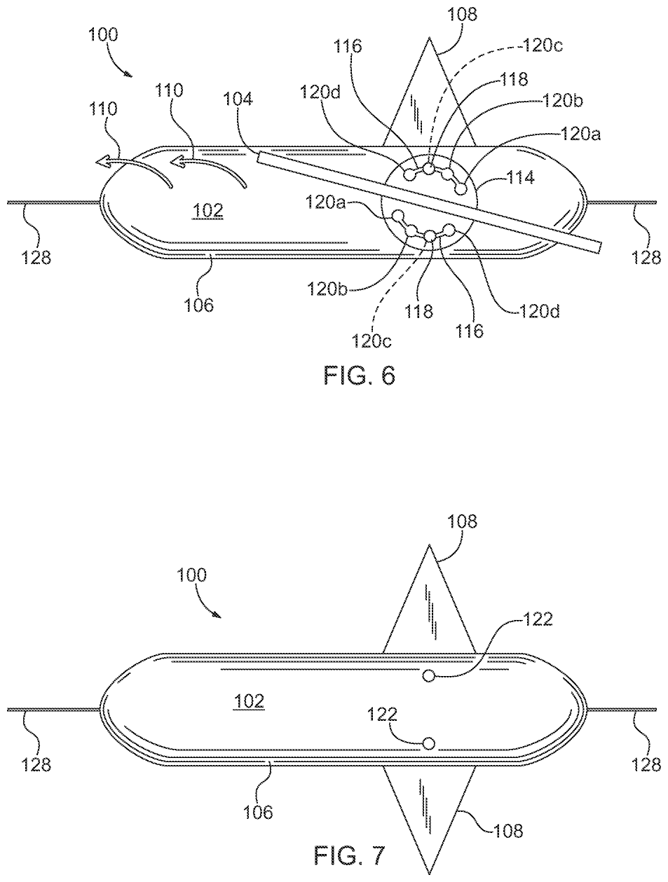

By way of illustration, pairs of corresponding notches 120 are depicted as 120a, 120b, 120c, and 120d (see FIGS. 4-6). Thus, as the rotatable base plate 114 is rotated and secured into different positions, e.g. 120a, 120b, 120c, and 120d, via screws 118 the keel 104 is adjusted to a new position or angle.

Alternatively, the body 102 may have at least a pair of threaded holes 122 for receiving screws 118 for securement of the rotatable base plate 114 with the keel 104 secured thereto, essentially locking the rotatable base plate 114 into a desired position and thereby locking the keel 104 at a desired angle. The threaded holes 122 should accommodate the screws 118 such that, when the screws 118 are inserted into the threaded holes 122, the screws 118 can be countersunk or essentially countersunk into the body 102 when tightened.

It is further contemplated that the keel 104 and the rotatable base plate 114 may be a single molded or machine piece.

As an alternative to the rotatable base plate 114, the keel 104 can be rotatable via a similar spring-loaded rotational assembly described above for the wing 108. In addition, the wing 108 may be adjustable via a similar rotatable base plate 114 described above for the keel 104.

The single line of a plurality of interconnected bait lures 100 may extend from a fishing vessel 112. The bait lures 100 can have a head end 124 and a tail end 126. The head end 124 is positioned to face towards the fishing vessel 112, and the tail end 126 is positioned opposite of the head end 124. The plurality of interconnected bait lures may be interconnected by a line 128 extending between the tail end 126 of the preceding bait lure and the head end 124 of the succeeding bait lure. This configuration effectively replicates a school of fish bait traveling in a single file line, such as baitfish, mollusks, worms, squid, crustaceans, and the like.

In an exemplary embodiment, a trolling device 101 includes a plurality of bait lures 100 arranged on a line 128. The line 128 can be made from metal, fiberglass, plastic, etc. The line 128 can be a single unitary line or a plurality of line segments. For instance, assuming the trolling device 101 comprises two bait lures 100 (e.g., a first bait lure 100 and a second bait lure 100). The trolling device 101 can include a single unitary line 128 extending from the tail end 126 of the first bait lure 100 and into the head end 124 of the second bait lure 100. If a third bait lure 100 is added, the line 128 can extend through the body 102 of the second bait lure 100, extend out from the tail end 126 of the second bait lure 100, and into the head end of the third bait lure 100. Alternatively, the trolling device 101 can include a first segment of line 128 extending from the tail end 126 of the first bait lure 100 and into the head end 124 of the second bait lure 100, and a second segment of line 128 extending from the tail end 126 of the second bait lure 100 and into the head end 124 of the third bait lure 100. It is understood that the trolling device 101 can have any one or combination of single line 128 or plural line 128 segments for any combination of bait lures 100.

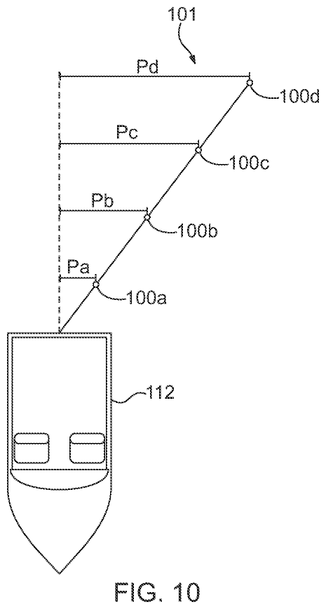

The trolling device 101 can have any number of bait lures 100. It is contemplated that the lateral separation P of the trolling device 101 increases as more bait lures 100 are added to the chain (see FIG. 1). For example, in reference to FIG. 10, if a user includes four bait lures (100a, 100b, 100c, and 100d) in a trolling device 101, the lateral separation P will increase with each bait lure 100 (e.g., Pd>Pc>Pb>Pa).

Any one or combination of bait lures 100 can be the same or different from other bait lures 100 on the line 128. For instance, any one or combination of bait lures 100 on the line 128 can have lateral wings 108 or a keel 104 while any one or combination of bait lures 100 may have no lateral wings 108 or no keel 104. Any one or combination of bait lures 100 may have one wing 108 or keel 104 while any one or combination may have more than one wing 108 or keel 104. Any one or combination of bait lures 100 may have adjustable wing(s) 108 or keel(s) 104 while any one or combination of bait lures 100 may have fixed wing(s) 108 or keel(s) 104.

As noted above, any one or combination of bait lures 100 on the line 128 can be configured (e.g., via the wing(s) 108, keel(s) 104, etc.) to provide stability and planing lift for that/those bait lure(s) 100. The combination of bait lures 100 on a line 128 can also provide stability and planing lift for the trolling device 101. While any one or combination of bait lures 100 can facilitate stability and planing lift for the trolling device 101, it is contemplated for each bait lure 100 to provide its own stability and planing lift so that the combination of all bait lures 100 on the line 128 provides stability and planing lift for the trolling device 101. As noted above, stability for each bait lure 100 refers to the movement behavior of the body 102 when moving forward that involves the body 102 planing without: skipping on the water surface; moving about erratically (e.g., flopping, spinning, rotating, etc.); undulating, diving, banking, listing, etc. Stability of the trolling device 101 refers to the movement behavior of the body 102 of each bait lure 100 when the trolling device 101 is moving forward that involves each body 102 of the device 101 planing without: skipping on the water surface; moving about erratically (e.g., flopping, spinning, rotating, etc.); undulating, diving, banking, listing, etc. It also involves movement behavior of the trolling device 101 without the line 128 squiggling (e.g., having a serpentine movement, having a fish-tail movement, etc.), without the bait lures 100 becoming tangled, etc. Planing lift for each bait lure 100 refers to providing enough lift to the body 102 to maintain planing—the body 102 maintains a position on top of or just below a surface of the water when moving forward. Planing lift for the trolling device 101 refers to providing enough lift to the body 102 of each bait lure 100 to maintain planing, and further involves providing enough lift for the device 101 so that each body 102 on the line 128 maintains a position on top of or just below a surface of the water when moving forward.

### EXAMPLES

The following examples serve to illustrate certain aspects of the disclosure and are not intended to limit the disclosure.

TABLE 1

| | | | Lateral | | | |
|---|---|---|---|---|---|---|
| | | | movement | | | |
| | | | outwards from | | | |
| | | Forward | normal straight | | | Ability to |
| Test | Lure Design Features | Speed | line of travel | | Stability | Self-Right |
| 1 | 1 lure - 2 wings and 1 | 7 Knots | 2.5 | degrees | Very good | Yes, within |
| | keel | | | | | 1 second. |
| | | | | | | Assembly |
| | | | | | | would |
| | | | | | | remain on |
| | | | | | | the surface |
| | | | | | | and quickly |
| | | | | | | self-right |
| 2 | 2 lure assembly - 2 | 7 Knots | 4 | degrees | Very good | Yes, within |
| | wings and 1 keel each | | | | | 1 second. |
| | | | | | | Assembly |
| | | | | | | would |
| | | | | | | remain on |
| | | | | | | the surface |
| | | | | | | and quickly |
| | | | | | | self-right |
| 3 | 4 lure assembly - 2 | 7 Knots | 7 | degrees | Very good | Yes, within |
| | wings and 1 keel each | | | | | 1 second. |
| | | | | | | Assembly |
| | | | | | | would |
| | | | | | | remain on |
| | | | | | | the surface |
| | | | | | | and quickly |
| | | | | | | self-right |
| 4 | 8 lure assembly - 2 | 7 Knots | 13 | degrees | Very good | Yes, within |
| | wings and 1 keel each | | | | | 1 second. |
| | | | | | | Assembly |
| | | | | | | would |
| | | | | | | remain on |
| | | | | | | the surface |
| | | | | | | and quickly |
| | | | | | | self-right |
| 5 | 4 lure assembly - 1 | 7 Knots | 3 | degrees | Only stable in | Yes, but |
| | wing and 1 keel each | | | | calm 2-3” | would go |
| | | | | | ripple. Acted | under water |
| | | | | | erratically in 1- | for 5 or more |
| | | | | | 2’ chop - | seconds |
| | | | | | flipped and | before |
| | | | | | dove below the | returning to |
| | | | | | surface | the surface |
| | | | | | | and self- |
| | | | | | | righting |
| 6 | 4 lure assembly - 0 | 7 Knots | 1 | degree | All lures would | No. Would |
| | wings and 1 keel each | | | | continually | not stop |
| | | | | | spin and | spinning. In |
| | | | | | occasionally | rough water, |
| | | | | | dive under the | would go |
| | | | | | surface | under water |
| | | | | | | and track |
| | | | | | | straight |
| 7 | 4 lure assembly - 2 | 7 Knots | 0 | degrees | Very good | Yes, within |

| | |
|---|---|
| wings and no keel | 1 second. |
| each | Assembly |
| | would |
| | remain on |
| | the surface |
| | and quickly |
| | self-right |

As seen in Table 1, seven lure assemblies with varying configurations were tested for their (a) stability and (b) ability to self-right. All of the lure assemblies had a constant forward speed of 7 knots. As noted above, stability refers to the movement behavior of a lure when moving forward and that involves forward movement without: skipping on the water surface; moving about erratically (e.g., flopping, spinning, rotating, etc.); undulating, diving, banking, listing, etc. Too much instability will render a lure unfishable, as its goal of attracting target species is negated by its instability. Further, a lure's ability to self-right to its ordinary position (e.g., with head end spearheading movement, keel below the surface of the water, and ventral surface facing the water) is critical for performance in rough sea conditions (i.e., 3-5′ waves). Specifically, if a lure flips while trolling and disappears under the surface of water, it is critical that the lure returns to the surface and quickly resumes normal functionality. The seven lure assemblies in Table 1 were forced to flip so each lure's ability to self-right could be observed.

The arrangement described in the embodiments discussed herein provide stability and planing lift for a trolling device 101 that has no rigid stabilizing structure. For instance, there is no spreader bar or any type of outrigger feature that can be used with such a trolling device 101, as it is desired to be a single line to represent a single file fish formation. Use of a spreader bar or other outrigger feature to provide stability to the line 128 is undesired and would detract from the natural look and operability of the device 101.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof.

Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A trolling device, comprising:
a plurality of interconnected bait lures, wherein at least one bait lure comprises:
a body;
a keel that extends from a ventral surface of the body at an angle relative to a longitudinal axis of the body, such that, when trolling in a body of water at or near a surface of the body of water, the body is guided laterally outwardly from a direction of travel;
a lateral wing extending outwardly from the body;
a head end; and
a tail end.

2. The trolling device of claim 1, wherein the plurality of interconnected bait lures are interconnected by a line extending between the tail end of a preceding bait lure and the head end of a succeeding bait lure.

3. The trolling device of claim 1, wherein the plurality of interconnected bait lures create a lateral separation when trolling, wherein the lateral separation increases as the number of interconnected bait lures increases.

4. The trolling device of claim 1, wherein at least one of the plurality of interconnected bait lures has at least one hook secured thereto.

5. The trolling device of claim 1, wherein the keel is configured to facilitate adjustment of the angle at which the keel makes relative to the longitudinal axis of the body.

6. The trolling device of claim 1, wherein at least one of the plurality of interconnected bait lures comprises:
a rotatable base plate comprising at least two sliding grooves for receiving screws to secure the rotatable base plate to the body, wherein the keel is affixed to the rotatable base plate.

7. The trolling device of claim 1, wherein at least one of the plurality of interconnected bait lures comprises:
a rotatable base plate comprising at least two sliding grooves and at least two notches for receiving screws to secure the rotatable base plate to the body, said notches being provided within the at least two sliding grooves, wherein the keel is affixed to the rotatable base plate.

8. The trolling device of claim 1, wherein at least one of the plurality of interconnected bait lures comprises:
a rotatable base plate comprising the keel secured thereto; and
the body having at least a pair of threaded holes for receiving screws for securement of the rotatable base plate to the body.

9. The trolling device of claim 8, wherein the keel and the rotatable base plate are a single molded or machine piece.

10. The trolling device of claim 8, wherein the rotatable base plate and the elongated body are configured such that the rotatable base plate is rotatable about a central axis while remaining on the body.

11. The trolling device of claim 8, wherein the rotatable base plate comprises at least one sliding groove through which screws are inserted to secure the rotatable base plate to the body via the threaded holes of the body.

12. The trolling device of claim 11, further comprising:
at least one pair of notches in the at least one sliding groove, said at least one pair of notches configured to accept the screws and permit said screws to be tightened into the threaded holes of the body.

13. The trolling device of claim 1, wherein the pitch of the wing is adjustable.

14. The trolling device of claim 1, wherein the body is an elongated body and configured to assist with planing lift.

15. A trolling device, comprising:
a bait lure, comprising:
a body;
a keel that extends from a ventral surface of the body at an angle relative to a longitudinal axis of the body, such that, when trolling in a body of water at or near a surface of the body of water, the body is guided laterally outwardly from a direction of travel;
a lateral wing extending outwardly from the body;
a head end; and
a tail end.
a line extending from the head end;
wherein the keel and the lateral wing work in conjunction to provide stability and planing lift for the bait lure when the bait lure is caused to troll in a body of water such that the bait lure maintains a position on or below a surface of the water in a stabile manner.

16. The trolling device of claim 15, further comprising a plurality of lateral wings.

17. The trolling device of claim 15, further comprising a plurality of keels.

18. A trolling device, comprising:
a plurality of bait lure, each bait lure comprising:
a body;
a keel that extends from a ventral surface of the body at an angle relative to a longitudinal axis of the body, such that, when trolling in a body of water at or near a surface of the body of water, the body is guided laterally outwardly from a direction of travel;
a lateral wing extending outwardly from the body;
a head end; and
a tail end.
wherein each preceding-succeeding bait lure pair of the plurality of bait lures includes a line extending between the tail end of the preceding bait lure and the head end of the succeeding bait lure; and
wherein the keel and the lateral wing of each bait lure work in conjunction to provide stability and planing lift for the trolling device when the trolling device is caused to troll in a body of water such that the trolling device maintains a position on or below a surface of the water in a stabile manner.

19. The trolling device of claim 16, wherein the line for the trolling device consists of a single unitary line.

20. The trolling device of claim 16, wherein the line for the trolling device comprises a plurality of line segments.
